(19) United States
(12) Patent Application Publication
(10) Pub. No.: US 2005/0038791 A1
(43) Pub. Date: Feb. 17, 2005

(54) System and method for event notification

(75) Inventor: Jacob B. Ven, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/640,788

(22) Filed: Aug. 13, 2003

(51) Int. Cl. G06F 7/00

(52) U.S. Cl. 707/100

(57) ABSTRACT

A system for event notification includes a notification provider configured with a list of event definitions, and emit notification instructions. The emit notification instructions are configured to receive events from a plurality of entities; compare a received event to the event definitions and determine whether to issue a notice of the event based on whether the received event corresponds to at least one of the event definitions; and transmit updated information associated with the event when a client that received the notice of the event requests the updated information.

### BACKGROUND

While personal computers have increased personal productivity, it is the networking of these computers that has revolutionized business processes with the accessibility of information and the speed with which it is shared. New technologies, new applications, and changes in network architecture continue to have major impacts on network performance. The problem of managing disparate IT resources is becoming more acute as systems are increasingly developed using IT resources that are deployed in remote locations and accessed via information networks, such as the Internet. Networks are typically designed to be modular and scalable, with load-balancing, redundancy, and built-in auto-recovery capabilities. Networks are often application-aware and prioritize traffic based on content. With so many technological features available and so many hardware permutations possible, administrative tools to manage network resources are continuously being developed.

Many types of modularized and/or distributed systems include an event notification system that enables resources to communicate information to one another upon the occurrence of one or more events. In some systems, the resources continuously poll each other for event messages. Polling event notifications requires messages to be passed back and forth between resources at regular intervals, whether or not an event has occurred. The system overhead required to conduct polling is directly proportional to the polling frequency. A conflict therefore arises between receiving timely notification of events and the overhead required to provide the notifications on a timely basis.

Some types of modularized, distributed systems include a dynamic number of resources. For example, an information network can include a variable number of workstations, peripherals, servers, and databases. Some of the resources emit event notifications to some or all other resources in the network. In many cases, some of the resources do not require notification of events from particular other resources.

Some systems reduce event traffic on a network by using an event filtering service. Additionally, certain resources that produce events pre-filter the events and cease producing events when there are no consumers for them. In one such system, all event producers support a “quench” operation to pass a subscription expression to the producer. This expression can be used by the producer to cease producing events that are no longer needed by any consumer; and determine which notifications to produce. In such systems, subscription information is transmitted to the original event producer, rather than allowing events to flow through the system to the consumer before being filtered. On the event producer side, interfaces for such event filtering services include operations that allow consumers to determine the event type available from an event producer. On the event consumer side, interfaces include operations that allow consumers to subscribe to particular events and receive notification of events that match their subscriptions.

There are virtually endless situations where timely notification of events can be utilized in performing tasks such as administering, monitoring, troubleshooting, controlling work queues, and controlling updates of data and other resources in a network. For example, an operator monitoring data may fill out a form to update the data using a wizard. When the wizard completes, the operator should see those new objects in his current views immediately. As another example, an operator monitors a message browser and is required to respond quickly when a new message arrives. The browser message view must present new messages as soon as the messages arrive. As a still further example, a network operator debugging a network router problem can use a browser view of the network from end to end. The router appears red signaling that it is not operating correctly. Another engineer reboots the router that is having the problem for another reason. The operator's view should change to show the router status change within a relatively short time period.

In addition to network administration, event notifications can further be used to control requests to data centers, call centers, help desks, and many other applications. An update in one server may affect a hierarchical tree of objects starting from a base object.

### SUMMARY

In one embodiment, a system for handling event notifications includes a notification provider configured with a list of event definitions, and emit notification instructions. The emit notification instructions are configured to receive events from a plurality of entities; compare a received event to the event definitions and determine whether to issue a notice of the event based on whether the received event corresponds to at least one of the event definitions; and transmit updated information associated with the event when a client that received the notice of the event requests the updated information.

In another embodiment, a network comprises a workflow layer configured to communicate with a notification provider. The workflow layer includes a client filter configured to receive event notifications and to determine whether to transmit the event notifications to the client based on event criteria established by the client.

In another embodiment, a method for issuing event notifications in a network, comprises registering a polling interval and event filter criteria for a client in a server. Event definitions are also stored in the server, and the server is polled for updated information at the expiration of each polling interval. The updated information is transmitted to the client when the updated information meets the event filter criteria and the event definitions.

### BRIEF DESCRIPTION OF THE DRAWINGS

Embodiments of the invention relating to both structure and method of operation, may best be understood by referring to the following description and accompanying drawings.

FIG. 1 shows an embodiment of a notification system capable of providing event notification when information is updated or changed.

FIG. 2 shows an embodiment of a network that includes components that can be configured to implement the notification system of FIG. 1.

FIG. 3A shows an embodiment of a network with an event forwarding discriminator (EFD), and arrows representing processes and components included in an embodiment of an event notification.

FIG. 3B shows the network of FIG. 3A, and arrows representing processes and components included in another embodiment of an event notification.

### DETAILED DESCRIPTION OF THE EMBODIMENTS

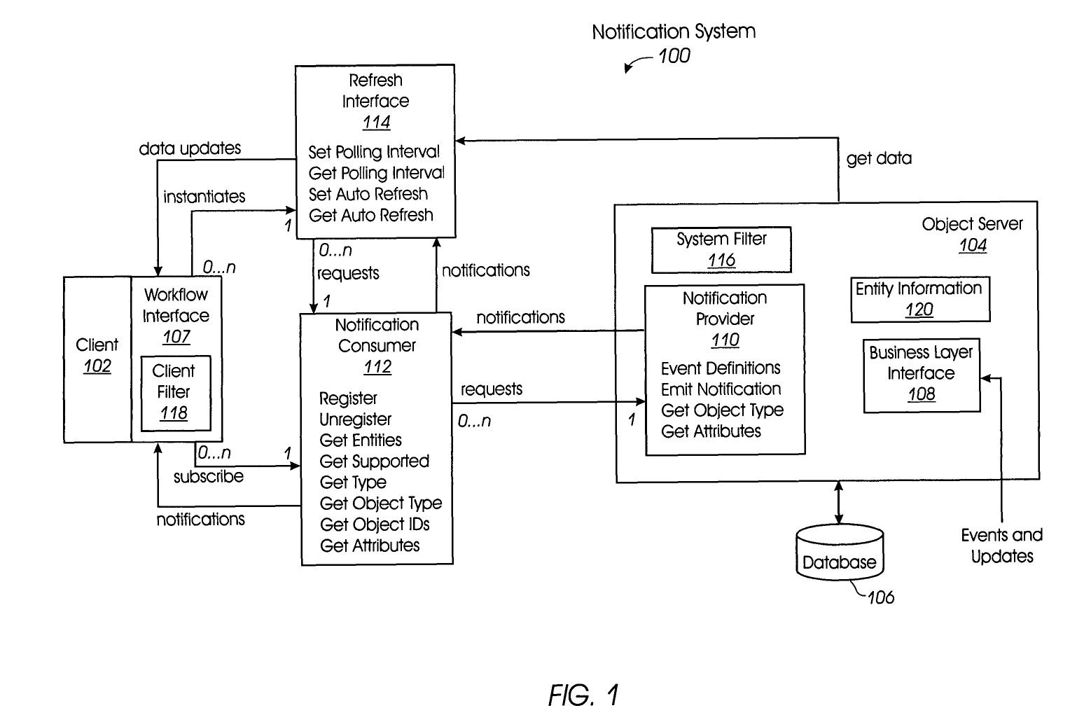

FIG. 1 shows an embodiment of a notification system 100 capable of providing event notification to client 102 when information accessible by object server 104 is updated or changed. Information can include, for example, data, application programs, transaction results, and status values from hardware and software network components. Information can change in a variety of way such as through user interaction, status reporting by entities that communicate with notification system 100, and as a result of completing one or more phases in a transaction. Examples of events that can be reported include changing or creating a new entry in database 106 or updating a software module. One or more clients 102 can subscribe to receive synchronous and/or asynchronous event notifications.

Client 102 can update information in database 106 via workflow interface 107, and object server 104. Object server 104 is configured to communicate with database 106, and issues a notice of changed data when client 102 updates information in database 106. Additionally, entities such as a computerized service, person, organization, node, or other object can submit events via business layer interface 108. In some embodiments, workflow interface 107 and business layer interface 108 can include a software developer's kit (SDK) interface or other suitable features to allow external entities to interface with notification system 100.

In the embodiment shown, notification system 100 includes notification provider 110, notification consumer 112, and refresh interface 114. Notification provider 110 includes various operations and features related to handling, filtering, and forwarding event notifications to notification consumer 112. Notification consumer 112 includes various operations and features related to receiving event notifications. Refresh interface 114 collaborates with notification consumer 112, and includes various operations and features related to loading and updating records of information. Notification provider 110, notification consumer 112, and refresh interface 114 can be implemented as application program interfaces (APIs) or other suitable computer programming structures or methods.

In some embodiments, notification provider 110 includes or has access to Event Definitions. The Event Definitions are used to determine whether a notification should be emitted. In some embodiments, each Event Definition includes the object type that is allowed to emit an event notification. Each Event Definition can optionally specify a list of attributes to indicate that an event notification does not need to be sent when the associated object type changes the specified attributes. The Event Definitions can be included in a database or a configuration file that is accessible by notification provider 110. Event Definitions can be read into memory during start-up initialization of notification provider 110, and can be dynamically updated during operation, as required.

Two or more sets of Event Definitions can be utilized to allow different entities to manage different subsections of a system. An implementation using more than one set of Event Definitions enables event notifications to be defined and issued based on a subsection of the system, thereby reducing the overall number of events and processing overhead required for event reporting and notification.

Notification provider 110 can also include an Emit Notification interface that allows entities to define and submit events via business layer interface 108. Entities are typically a logical unit, such as a service, node, person, peripheral, or organization, for example, that communicate with notification system 100. Entities can comprise one or more objects. When entities are operating, they can submit an event to notification provider 110 that includes information such as an identifier of the event, the type of object that generated the event, and/or a list of attributes that changed as a result of the event.

Notification provider 110 can determine whether a submitted event is allowed by comparing the submitted event to the Event Definitions that are already configured for notification system 100. In some embodiments, if the object type and attributes of the submitted event match one of the Event Definitions, then the submitted event is forwarded to all subscribers who registered to receive particular types of events, events from a particular entity, or events from a particular type of object. The Emit Notification interface can return information to the entity that submitted event, such as the number and identity of other objects to which the submitted event was forwarded.

Notification system 100 can be configured to enable system filter 116 to perform relatively light filtering on an event and send a very simple notification of the event to all clients 102 that meet the filtering criteria. Sending simple notifications that do not include a large amount of data reduces the overhead imposed on object server 104 to filter the event before sending notification of the event to client(s) 102. The simple notifications can be referred to as “a tickle.” Conversely, some clients 102 may receive notice of the event even though they will not be interested in the event. If a client 102 is interested in the event, however, then client 102 can pull the updated information from object server 104.

As an example of “tickle and pull” event notification, an operator view includes a table of network nodes that have critical status. Client 102 associated with the operator's view receives a “tickle” that an event occurred on a first node. The first node is not in the operator's domain of responsibility, so client 102 disregards the event and does not pull the updated data for the first node from object server 104. Subsequently, client 102 receives a notification of an event on a second node. If the second node is within the operator's domain of responsibility, client 102 will retrieve the updated data from object server 104.

Notification provider 110 can also include other notification operations, such as Get Object Type and Get Attributes operations, as shown in FIG. 1. The Get Object Type operation can provide information such as the type of object that generated a particular notification. The Get Attributes operation can provide information such as attributes that were changed. The attributes can represent information that was updated or created, as well as any other information that may be useful to notification consumer 112. Other suitable operations and features can also be included in notification provider 110.

System filter 116 can be included on object server 108 perform one or more levels of filtering on the notifications. For example, system filter 116 can store queries associated with sessions on client 102 that are used to determine whether a particular update should be sent to a particular client 102. The term “session” pertains to one or more sets of information that are available to be used by client 102 at a particular time. The information for a session can be presented on a display associated with user interface 104, for example. When queries are available in system filter 116, the associated clients 102 are notified only when there are relevant updates for the client's current session information. Clients 102 can update the queries utilized in system filter 116, such as when clients 102 change sessions. System filter 116 can also include one or more sets of Event Definitions in addition to, or instead of, the Event Definitions shown in notification provider 110.

System filter 116 helps reduce the amount of network traffic associated with events, since the notifications are only sent to clients 102 that need to be notified of particular events. Notifications can include varying levels of information, depending on the level of filtering that occurs in system filter 116. In some embodiments, notifications include just enough information to allow client filter 118 to determine whether to poll notification provider 110 for additional information. In other embodiments, notifications can include more information about the notification including the new or updated information, thereby eliminating the need for client 102 to poll notification provider 110 for the updates. In such embodiments, client filter 118 and client 102 include logic instructions to query and process updates via the information included in the notifications.

In still other embodiments, object server 104 can include entity information 120, such as object types and one or more filter criteria for each entity, as well as for sessions on client 102. Entities and clients 102 can be grouped into subsets according to the object types and/or filter criteria. The notifications can be sent to subsets of clients 102 and other entities that are affected by the updated information.

In still other embodiments, entity information 120 can include object types used by each session, and send notifications only to clients 102 of the object types that are affected by the updated information. Entity information 120 can be extended to store object types, object ID's, and other information. System filter 116 can be configured to send update and delete notifications to clients 102 that are using the information, whereas create notifications can be sent to all clients 102. Another option for implementing system filter 116 is to filter the information per object type, along with configurable attributes whose values create subsets that are evaluated by system filter 116.

An alternative to using system filter 116 is to notify all clients 102 of all updates to all information. Although eliminating system filter 116 can reduce the filtering workload on object server 104, the traffic in notification system 100 and the overhead to evaluate the notifications on client 102 is likely to increase.

Notification consumer 112 includes various operations and features related to receiving event notifications. In the embodiment shown, notification consumer 112 includes Register and Unregister operations that allow client 102 to subscribe and unsubscribe for event notifications from specified entities, object types, and/or event types. Client 102 is then notified when the events that meet the specified criteria occur. Client 102 can unsubscribe by specifying the entity, object type, and/or event type from which client 102 no longer desires to receive event notifications. The subscribe and unsubscribe requests are forwarded from client 102 to notification consumer 112 via workflow interface 107. Notification consumer 112 forwards the requests to notification provider 110. One or more entities, object type, and/or event types can be specified when the Register and Unregister operations are invoked to allow client 102 to subscribe and unsubscribe for event notifications from more than one entity, object type, or event type at a time. Other criteria for subscribing to events can be implemented in notification system 100, in addition to, or instead of, entities, object types, and event types.

Notification consumer 112 can also include a Get Entities operation to enable client 102 to request a list from notification provider 110 of the event criteria for which client 102 has subscribed to receive notifications. Additionally, notification consumer 112 can include a Get Supported operation to allow client 102 to request a list from notification provider 110 of the entities, object types, and event types that are allowed to emit notifications. Notification consumer 112 can receive the list of the event criteria upon initialization, and notification provider 110 can be configured to provide updates to the list of event criteria when certain conditions are met, for example, when requested by client 102, when the number of updates reaches a pre-specified number, and/or after a pre-specified amount of time.

Notification provider 110 issues notifications of events to all clients 102 who have subscribed to receive notifications that meet the specified event criteria. Clients 102 can then determine whether they wish to receive the full update using client filter 118.

Notification consumer 112 can include operations to extract the information and attributes from the notification. In some embodiments, the notice of the event from notification provider 110 includes the type of change that occurred, the type of object that submitted the event, an identifier of the object that submitted the event, and/or attributes representing the updated information. Client 102 can utilize operations such as Get Type, Get Object Type, Get Object ID, and Get Attributes in notification consumer 112 to determine whether to request the updated information, as well as to request the updated information.

For example, Get Type operation enables client 102 to query the type of change that occurred. In some embodiments, the types of changes include DELETE for information that was deleted; CREATE for information that was created; UPDATE for existing information that was changed; and MIXED to indicate a combination of DELETE, CREATE, and/or UPDATE. As another example, notification consumer 112 can include a Get Object Type operation to enable client 102 to query the type of object to which the notification pertains. An operation such as Get Object IDs can be included in notification consumer 112 to allow client 102 to get a list of objects that were affected by the change. A Get Attributes operation can return a list of attributes that were changed to client 102. The operations in notification consumer 112 can be configured to retrieve the information from the notification, and/or to issue requests for the information to notification provider 110. Other suitable operations and features can be included in notification consumer 112.

Refresh interface 114 collaborates with notification consumer 112 and includes refresh operations that load records of information and update the information according to a specified method. For example, information can be updated at specified time intervals, or whenever notifications arrive. In some embodiments, refresh interface 114 includes Set Polling Interval, Get Polling Interval, Set Auto Refresh, and Get Auto Refresh operations. Client 102 can instantiate the operations in refresh interface 114 via workflow interface 107.

In some embodiments, the Set Polling Interval operation allows client 102 to specify the length of the interval between polling notification provider 110 for event notifications. The Get Polling Interval operation returns the polling interval to client 102 via workflow interface 107. The Set Auto Refresh operation in refresh interface 114 allows client 102 to turn automatic refresh of information on and off, and to specify a threshold number of refreshes that can occur in a specified time period before temporarily disabling automatic refresh of the information. The ability to control the number of times the information will be refreshed within a specified time interval prevents notification system 100 from becoming overwhelmed when numerous events occur.

Refresh interface 114 can also include a Get Auto Refresh operation to allow client 102 to query the state of refresh settings. For example, the Get Auto Refresh operation can return information regarding whether auto-refresh is enabled; the threshold rate of incoming notifications required to temporarily suspend refreshing data; and an auto-resume flag indicating whether to resume automatically refreshing the data when the rate of incoming notifications fall below the specified threshold. Other suitable operations and features can be included in refresh interface 114 in addition to, or instead of, Set Polling Interval, Get Polling Interval, Set Auto Refresh, and Get Auto Refresh operations. Additionally, workflow interface 107, notification system 100, object server 104, and business layer interface 108 can be configured to push or pull events from one another.

In some embodiments, notification system 100 handles bulk requests between notification provider 110 and client 102. For example, workflow interface 107 can support one or more clients 102. Workflow interface 107 can aggregate requests from multiple clients 102 and issue one subscription request to notification consumer 112, and/or instantiate refresh operations via refresh interface 114. Refresh interface 114 can aggregate several requests for updates to information, and issue one request to notification consumer 112. Similarly, notification consumer 112 can aggregate multiple requests for information, and issue one request to notification provider 110.

Thus, in some embodiments, a single “tickle” notification can be sent to multiple objects. All the requests for the updated information from the objects can than be “pulled” from object server 104 via one message that includes the request and identifiers for all of the objects that requested the update. For example, a network administration utility detects one hundred new nodes connected to a network and writes information about the new nodes to database 106. When notification provider 110 detects the change in database 110, notification provider 110 issues one message that includes notification of the event and identities the new nodes to notification consumer 112. Such embodiments relieve notification provider 110 from issuing one hundred individual notifications of the events.

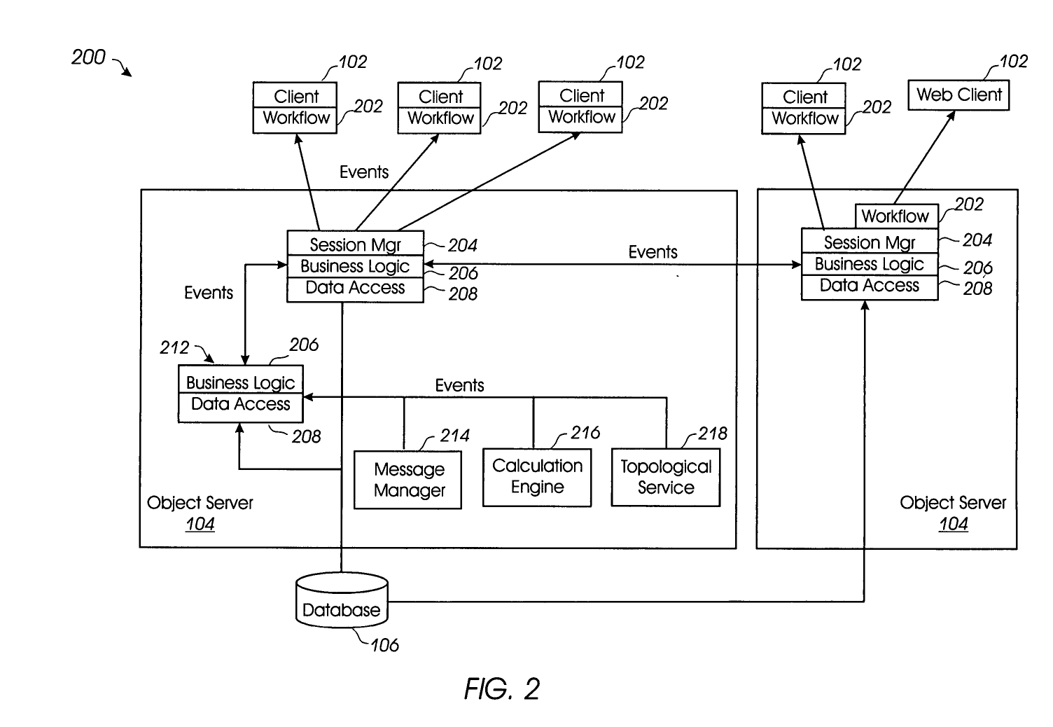

Referring now to FIG. 2, an embodiment of network 200 shows components that can be configured to implement notification system 100 (FIG. 1). Network 200 includes one or more object servers 104, and four main layers of components: workflow layer 202, session management layer 204, business logic layer 206, and data access layer 208. Workflow layer 202 can include workflow interface 107 (FIG. 1) and performs functions such as managing process execution, providing a consistent interface for the lower-level components, and transforming native data to/from a common language, such as the extensible markup language (XML). Session manager 204 manages a collection of clients 102. For example, on login, session manager 204 might start a mail reader, calendar, and editor. Clients 102 also respond to messages from session manager 204, such as a message to save the internal state before termination, or to delete a window from a user interface generated by client 102. Business logic layer 206 can include business layer interface 108 (FIG. 1), and provides models and rules associated with performing functions of network 200. Data access layer 208 provides a common interface for retrieving data from multiple sources regardless of its type.

Network 200 can include a consolidation server 212 that provides a common interface to other components in network 200, such as message manager 214, calculation engine 216, and topology service 218. Consolidation server 212 can also include business logic layer 206 and data access layer 212, and can interface with one or more object servers 104. Message manager 214 provides message communication and synchronization capabilities. Functions that can be performed by message manager 214 include creating, identifying, and deleting message queues, and reordering, broadcasting, receiving, synchronizing, deleting, and counting messages in a queue. Calculation engine 216 is configured to perform computationally intensive functions, and can include features such as array processors and high-speed floating point registers. Topology service 218 performs functions such as keeping track of the location of components in network 200 and how they are related to other components. Topology service 218 can provide topological information to clients 102 upon request. Other suitable network components can also be coupled to consolidation server 212.

Referring to FIGS. 1 and 2, notification system 100 can be implemented in various components of network 200 to communicate notification of events and information between clients 102 and object servers 104. For example, notification provider 110 can be implemented in session manager 204, while notification consumer 112 and refresh interface 114 can be implemented in workflow 202. Notification system 100 can be implemented in other suitable components, in addition to, or instead of, session manager 204 and workflow 202.

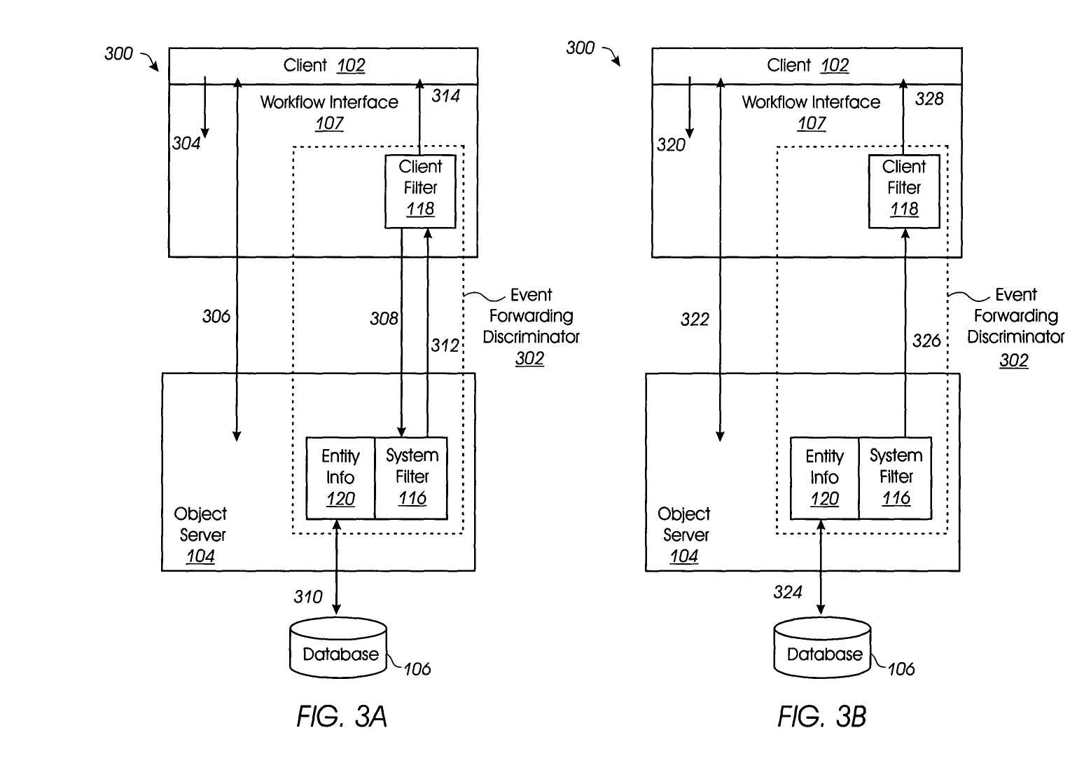

Referring to FIG. 3A, an embodiment of network 300 is shown with client filter 118, entity information 120, and system filter 116, which are referred to collectively as event forwarding discriminator (EFD) 302. In some embodiments, an EFD 302 is created with each invocation of the Register operation in notification consumer 112 (FIG. 1). EFDs 302 can be read into memory during start-up initialization, and updated during operation, for example, when one of the filter queries changes, or a new entity begins communicating with notification system 100 (FIG. 1). Notification system 100 can also include operations to return a list of EFDs 302 defined for a particular session; change an existing EFD 302; remove an EFD 302; and create and send a customized notification.

A push model and a pull model for issuing event notifications can be provided in network 300. With the push model, event suppliers, such as object server 104, push events to EFD 302, which in turn pushes the notifications to event consumers, such as client 102. For the pull model, the event consumers pull notifications from EFD 302, and EFD 302 pulls notifications from the suppliers.

A hybrid push/pull model can also be implemented in network 300. For example, in process 304, client 102 can register a polling interval, callback routine, and one or more filter queries via workflow interface 107. If client 102 opens one or more entities, information about the entities and their filter queries can also be stored in entity information 120 and system filter 116, as indicated by process 306. Object server 104 can also load Event Definitions from database 106 in system filter 116 and/or notification provider 110 (FIG. 1). Workflow interface 107 polls for new or updated information at the expiration of each polling interval via client filter 118, as indicated by process 308. The updated/new information is retrieved from database 106, as indicated by process 310, and returned to client filter 118, as indicated by process 312. In some embodiments, system filter 116 can compare the new information with the previous information, and only return the records which have changed between intervals. Additionally, in some embodiments, object server 104 returns a list of notifications instead of records containing updated or new information. Further filtering on the notifications can occur at client filter 118 to determine whether to request the updated information. The requested information can then be forwarded as requested to client 102, as indicated by process 314.

Referring to FIG. 3B, an example of a push event notification model for network 300 is shown. In process 320, client 102 registers a callback routine, and one or more filter queries, via workflow interface 107. If client 102 opens one or more entities, information about the entities and their filter queries can be stored in entity information 120 and/or system filter 116, as indicated by process 322. Object server 104 can also load Event Definitions from database 106 in system filter 116. In process 324, a change to database 106 triggers system filter 116 to compare the changed information with information stored in entity information 120 and system filter 116. Updated and new information is forwarded to client filter 118, as indicated by process 326, where another level of filtering can be performed on the information. In some embodiments, system filter 116 can compare the new information with the previous information, and return only the records which have changed between intervals. Additionally, in some embodiments, object server 104 returns a list of notifications instead of records containing updated or new information. Further filtering on the notifications can occur at client filter 118 to determine whether to request the updated information. The requested information is then forwarded to client 102, as indicated by process 328. In other embodiments, client 102 can indicate whether notification provider 110 should send the updated information, or just notices of the events, in notification messages.

In addition to determining whether client 102 should receive event notifications and updated information, EFD 302 can include logic to handle arrival of new notifications while evaluating a previous notification, add new clients 102 to network 300, synchronize populating information for a session, and handle notifications that change a data set being populated. In the examples shown in FIGS. 3A and 3B, notification and information filtering is distributed between business logic layer 206 and workflow layer 202 (FIG. 2). Business logic layer 206 typically performs coarse filtering, and based on the results of the coarse filtering, the notification and/or the updated information is forwarded to the interested workflow layers 202. Client filter 118 performs a finer level filtering in workflow layer 202, and then forwards the notification and/or the updated information via the registered callback routine for client 102.

There are a number of situations in which notification system 100 can be utilized. One example includes network administration, wherein an operator supplies new or updated information regarding an entity via a form wizard. When the operator finishes the form, the wizard creates multiple objects that are sent as updated information to object server 104, and which should appear in the current session view at client 102. Notification system 100 can also notify other interested entities of the updated information. The notified entities can then decide whether to update their session views. Alternatively, in a push model, the updated information is sent automatically to entities registered to receive automatic updates. Notification system 100 can supply updated information within a specified time interval to provide an operator responsible for monitoring a system with the most recent information available.

A further example of the utility of notification system 100 pertains to a network operator debugging a problem with a router. Some debugging tools provide an end-to-end view of a network. The router can be presented in the view with a problem indicator signaling that the router is not operating correctly. If another operator reboots the router, the first operator's session view can change to show the router operating correctly within a specified interval.

Another example pertains to a customer service call center with groups of specialists that are organized according to knowledge domains. After initial assessment by the first line help desk, calls are sent to a work queue for the most appropriate group of specialists. Specialists can use a session view of calls assigned to workgroups to which the specialist belongs, and can assign calls to themselves. As soon as a specialist assigns a call to him or herself, other specialists are informed that the call has been retrieved by someone else to prevent other specialists from trying to assign the call to themselves.

As a variant of the preceding example, a help desk team is responsible for notifying customers when a trouble report is solved. When the specialist has solved the problem, they change the status of the call to ‘solved’ and send it back to the help desk. The help desk team uses a session view that presents calls assigned to the help desk with status ‘solved’. The first available person to pick up the call assigns it to himself/herself, and notifies the customer. Other team members' views can be updated to prevent them from trying to pick up the call.

In another example, a specialist can open an incident report generated by a system management tool. Once the incident report is opened, the status of the incident is updated, which generates an event in notification system 100. Notification of the event can be sent to other entities, as well as the entity that generated the event. The session view of the specialist changes to reflect the updated information.

Processing components such as client 102 and object server 104 included in notification system 100 and networks 200, 300 are typically implemented in computer processing systems, respectively. Processing systems for components in notification system 100 and networks 200, 300 can be any suitable computer-processing device that includes memory for storing and executing logic instructions, and is capable of interfacing with other processing systems. In some embodiments, components in notification system 100 and networks 200, 300 can communicate with other external networks via suitable interface links such as any one or combination of T1, ISDN, cable line, a wireless connection through a cellular or satellite network, or a local data transport system such as Ethernet or token ring over a local area network.

Various input/output devices, such as a keyboard and mouse (not shown), can be included to allow a user to interact with components internal and external to notification system 100 and networks 200, 300. Additionally, processing systems for notification system 100 and networks 200, 300 can be embodied in any suitable computing device, and so include personal data assistants (PDAs), telephones with display areas, network appliances, desktops, laptops, X-window terminals, or other such computing devices.

Logic instructions can be stored on a computer readable medium, or accessed in the form of electronic signals. The logic modules, processing systems, and circuitry described herein may be implemented using any suitable combination of hardware, software, and/or firmware, such as Field Programmable Gate Arrays (FPGAs), Application Specific Integrated Circuit (ASICs), or other suitable devices. The logic modules can be independently implemented or included in one of the other system components. Similarly, other components have been discussed as separate and discrete components. These components may, however, be combined to form larger or different software modules, logic modules, integrated circuits, or electrical assemblies, if desired.

While the invention has been described with reference to various embodiments, it will be understood that these embodiments are illustrative and that the scope of the invention is not limited to them. Many variations, modifications, additions and improvements of the embodiments described are possible. For example, those having ordinary skill in the art will readily implement the steps necessary to provide the structures and methods disclosed herein, and will understand that the components and their arrangement are given by way of example only. The configurations can be varied to achieve the desired structure as well as modifications, which are within the scope of the invention. Variations and modifications of the embodiments disclosed herein may be made based on the description set forth herein, without departing from the scope of the invention as set forth in the following claims. In the claims, unless otherwise indicated the article “a” is to refer to “one or more than one”.

1. A system for handling event notifications, comprising:
a notification provider including:
a list of event definitions; and
emit notification instructions configured to:
receive events from a plurality of entities;
compare a received event to the event definitions and determine whether to issue a notice of the event based on whether the received event corresponds to at least one of the event definitions; and
transmit updated information associated with the event when a client that received the notice of the event requests the updated information.

2. The system of claim 1, further comprising a system filter, wherein the system filter includes entity queries, and the system filter is configured to compare the received event to the entity queries and to issue notice of the event when the received event corresponds to at least one of the entity queries.

3. The system of claim 1, further comprising entity information regarding entities that can submit events, wherein the notification provider includes instructions configured to transmit at least a portion of the entity information upon request.

4. The system of claim 3, wherein the entity information includes types of objects in the entities that can submit events.

5. The system of claim 3, wherein the entity information includes attributes of the entities that can submit events.

6. The system of claim 1, further comprising a business layer interface configured to allow an entity to submit events to the notification provider.

7. The system of claim 1, further comprising:
a notification consumer configured to communicate with the notification provider, wherein the notification consumer includes:
register instructions configured to allow the client to subscribe to specified event notifications.

8. The system of claim 7, wherein the notification consumer further includes logic instructions configured to allow the client to query information about the plurality of entities and the events supported by the notification provider.

9. The system of claim 1, further comprising a workflow interface configured to send data updates from a client to a database, wherein sending the data updates includes submitting a data update event to the notification provider.

10. The system of claim 1, further comprising a client filter configured to filter events for a client to determine whether the client should receive the information associated with the events.

11. The system of claim 1, further comprising a refresh interface configured to allow a client to set polling intervals for receiving notifications from the notification provider.

12. The system of claim 11, wherein the notification system is configured to handle bulk requests between the notification provider and a plurality of clients.

13. The system of claim 9, wherein the workflow interface is configured to communicate with a plurality of clients, aggregate requests from at least a portion of the plurality of clients, and issue one message that includes the request from the portion of the plurality of clients and identifiers for the portion of the plurality of clients.

14. The system of claim 11, wherein the refresh interface is configured to communicate with a plurality of clients, aggregate several requests for updates to information from at least a portion of the plurality of clients, and issue one message that includes the request from the portion of the plurality of clients and identifiers for the portion of the plurality of clients.

15. The system of claim 7, wherein the notification consumer is configured to aggregate multiple requests for information from a plurality of objects; issue one request for the information to the notification provider; receive the requested information from the notification provider; and distribute the information to the objects that requested the information.

16. A network comprising:
a workflow layer configured to communicate with a notification provider, wherein the workflow layer includes:
a client filter configured to receive event notifications and to determine whether to transmit the event notifications to the client based on event criteria established by the client.

17. The network of claim 16, further comprising:
a refresh interface; and
a workflow interface configured to communicate data updates from the client to the refresh interface.

18. The network of claim 16, wherein the refresh interface is further configured to allow the client to instantiate polling intervals for event notifications via the workflow interface.

19. The network of claim 16, wherein the refresh interface is further configured to allow the client to control the number of notifications sent to the client.

20. The network of claim 17, further comprising:
a notification consumer configured to communicate with the refresh interface and the workflow interface, and to allow the client to subscribe to specified event notifications.

21. The network of claim 20, wherein the event notifications can be specified by at least one of the group of: entity, object type, object identity, and event type.

22. The network of claim 21, wherein the notification consumer issues requests from the client to the notification provider, and receives notifications from the notification provider.

23. The network of claim 17, further comprising:
an object server; and
the notification provider, wherein the notification provider is implemented in a session manager layer on the object server.

24. The network of claim 23, wherein the object server further comprises:
a business layer interface configured to submit events to the notification provider; and
a system filter configured to send notification of the events to the client when the event corresponds to event criteria registered by the client.

25. The network of claim 20, wherein the notification consumer is configured to issue a plurality of requests to the notification provider in one message.

26. A method for issuing event notifications in a network, comprising:
registering a polling interval for a client in a server;
storing event definitions in the server;
receiving an event from an entity, wherein the event is associated with an update to the entity's information;
transmitting a notice of the event to the client when the event corresponds to at least one of the event definitions; and
receiving a request from the client for the updated information when the event corresponds to event filter criteria implemented in the client's workflow layer.

27. The method of claim 26 further comprising:
storing information regarding entities that supply events.

28. The method of claim 26 further comprising:
comparing the updated information with previous information; and
returning the records of the updated information which have changed from the previous information.

29. The method of claim 26, further comprising.
transmitting a notification of the event to the client instead of the updated information.

30. The method of claim 26, further comprising.
performing additional filtering on the notifications in a workflow layer before the updated information is sent to the client; and
sending the updated information to the client when the updates information satisfies filter criteria established by the client.

31. An apparatus for controlling event notifications in a network, comprising:
means for storing event definitions;
means for determining whether submitted events correspond to at least one of the event definitions;
means for filtering the submitted events according to event filter criteria established by an entity to determine whether to transmit notification of the event to the entity;
means for comparing updated information associated with the event with previous information; and
means sending only the records of the updated information which have changed from the previous information.

32. The apparatus of claim 31 further comprising:
means for storing information regarding entities that submit events.

33. The apparatus of claim 31, further comprising.
means for performing additional filtering on the notifications before the updated information is sent to a client; and
means for sending the updated information to the client when the updates information satisfies filter criteria established by the client.
